(19) United States
(12) Patent Application Publication
(10) Pub. No.: US 2008/0299258 A1
(43) Pub. Date: Dec. 4, 2008

(54) Probiotic natural sweetener compositions with standardized levels of fiber and process to make

(76) Inventors: Stephen B. Roman, Phoenix, AZ (US); Gary S. Kehoe, Phoenix, AZ (US); Ronald C. Deis, West Chester, PA (US)

Correspondence Address: TOD R NISSLE, PO BOX 55630, PHOENIX, AZ, 85078, US

(21) Appl. No.: 12/148,045

(22) Filed: Apr. 16, 2008

Related U.S. Application Data
(60) Provisional application No. 60/923,996, filed on Apr. 18, 2007.

(51) Int. Cl. A23L 1/29

(52) U.S. Cl. 426/71

(57) ABSTRACT

A natural prebiotic syrup concentrate with levels of inulin greater than 30% by weight.

This application claims priority based on provisional patent application Ser. No. 60/923,996 filed Apr. 18, 2007.

The present disclosure relates to prebiotic sweetener compositions and the process to make them that are expected to provide higher levels of natural fiber as inulin when compared to other natural sweeteners in the market place.

Syrups derived from agave succulents have been used for many years in various parts of Latin America for its natural sweeteness. It has been used in beverages and confections and even in baked goods and dairy products. Its use has predominately been as a sweetener although it does contain a natural amount of fiber as inulin. No one has focused on refining the process of the agave syrup extraction to the point of developing new standardized products for use as prebiotic, bulk sweeteners to the food industry.

Prebiotics are important to maintaining a healthy digestive system in humans. Many consumers eat yoghurts which have probiotics to keep their digestive system in good balance. These probiotics do need a good source of nutrition in order to stay alive and well. Prebiotics such as fiber are good sources for the nutrition that probiotics need in order to survive. Providing a sweetener composition that naturally contains a good source of prebiotic fiber is a needed benefit to the food industry and to consumers.

Agave syrups are commercially derived by two different processes. In one process the salmiana agave is broken at the base of the stock and the well of liquid syrup is exposed. This syrup is then further filtered and cleaned so that it can be packaged into bulk containers and sold to consumers. The crude syrup naturally contains fiber as inulin but its sweetness is relatively low. The crude syrup is further processed in order to break down the inulin fiber into fructose, which is much sweeter than the crude syrup. The resulting finished agave syrup then contains only between 6 and 12% inulin with a relative sweeteness of 1.25 to 1.4 times as sweet as sucrose.

The second process uses blue agave pulp. The root ball or ‘pina’ is separated from the leaves of the agave, cut into smaller pieces, then pressed to extract the crude syrup within. The crude syrup naturally contains fiber as inulin but its sweetness is relatively low. The crude syrup is further processed in order to break down the inulin fiber into fructose in similar fashion to the process for salmiana agave. The resulting finished agave syrup then contains between 20 and 28% fiber as inulin with a sweeteness compared to sucrose of 1.2 to 1.5 times sweeter.

The resulting syrups are then sold to tequila distillers or packaged for sale to consumers as a natural sweetener.

These syrups are limited in use due to their high cost relative to other industry bulk sweeteners such as sugar, fructose corn syrup and high fructose corn syrup. They are also limited by the low level of inulin that they contain. The agave syrups available in the market place do not have consistent levels of inulin from batch to batch, making it difficult for food formulators to use the syrups and create finished products with reliable nutritional label claims. For these reasons, formulators are forced to use other sources of fiber in conjunction with the commercially available bulk sweeteners to attain repeatable finished food products.

Sweetener syrups derived from agave are known. Sweetener syrups derived from agave with concentrations of fiber as inulin ranging from 6 to 28% are known. Sweetener syrups derived from agave with concentrations of inulin above 30% are not known. This invention is novel in that it allows food formulators to formulate with a natural prebiotic, sweetener that has a higher sweeteness profile than sugar with the added health benefits of a high content of natural inulin fiber.

The disclosure relates to prebiotic compositions, both liquid and solid, comprising water, a natural sweetener and fiber resulting in compositions with comparable sweetness to sugar and/or corn syrup but with the added benefit of a highly concentrated nutritional fiber resulting in a natural prebiotic sweetener composition. The proprietary composition is novel in that it contains a standardized level of inulin at levels above 10%, which are not available in the market place today. The new composition may use additional high potency sweeteners in addition to a natural sweetener to increase the overall sweetness level of the composition, but with a much lower glycemic index than sugar or high fructose corn syrup.

The resulting product will be a mixture of, but not limited to: water, agave syrup, and a source of fiber, such as preferably inulin. Other ingredients such as high intensity sweeteners, flavors, acids, extracts, fruit concentrates, syrups, minerals, appetitie suppressants, honey, lo han guo, thaumatin, neohesperidin, dihydrochalcone, monatin, and the like, may be incorporated into the compositions.

Nutritional foods are ever increasing in the market place as consumer health becomes a priority for the food industry and consumers alike. A specific area of concern is gut health. This new composition will allow the food industry to formulate with a natural, prebiotic sweetener which has a low glycemic index when compared to sugar, while being sweeter than sugar and also with the important benefit of providing a natural source of nutritional fiber at standardized level. The sweetener applications range from, but are not limited to, confectionery and dairy to frozen desserts and baked goods.

The disclosure relates to prebiotic compositions, both liquid and solid, comprising water, a natural sweetener and fiber resulting in compositions with comparable sweetness to sugar and/or corn syrup but with the added benefit of a highly concentrated nutritional fiber resulting in a natural prebiotic sweetener composition. The proprietary compositions are novel in that each contains a standardized level of inulin at a different level above 10%, which compositions are not available in the market place today, e.g., a first composition includes 10% by weight inulin, a second composition includes 20% by weight inulin, a third composition includes 30% by weight inulin, a fourth composition includes 40% by weigh tinulin, and so on. The new compositions may use additional high potency sweeteners in addition to a natural sweetener to increase the overall sweetness level of the composition; however, the new compositions have a much lower glycemic index than sugar or high fructose corn syrup. Such new compositions containing at least 30% by weight inulin are especially desirable because of the high fiber content.

Process to Make:
(a) The Agave pulp or root base is cut into smaller pieces that can be milled. The pulp is separated from the crude syrup.
(b) The crude syrup is then run through a series of carbon activated filters and mesh screen filters to remove any impurities
(c) Crude agave syrup is metered, or weighed into a mixing vessel;
(d) The crude syrup is then subjected to a controlled hydrolysis to yield the desired ratio of fructose to inulin and the resulting fructose/inulin syrup is collected.
(e) Minerals, color and flavor off-notes are removed via chromatography.
(f) The water is then evaporated off to further concentrate the ratio of fructose syrup to inulin to the desired levels.
(g) The evaporation process is continued until the desired amount of inulin/fructose concentration is attained.
(h) High intensity sweeteners or other additives can be blended in at this point.
   To produce the dry form of the natural inulin/fructose concentrate, the steps below are initiated. If only a syrup or paste is desired, the process stops at the last step above:
(i) The resulting syrup or paste/concentrate is then spray dried using a conventional spray dry equipment and techniques to yield a naturally sweet inulin powder.
(j) After the spray drying step, further additives may be added in an agglomeration method or a simple add-mix ribbon type blender.

In the Case of Liquid Compositions:

The resulting product will be a mixture of, but not limited to: fructose, inulin and water. Other ingredients such as natural sweeteners, naturally sweet syrups (such as brown rice, tapioca, and evaporated can juice, etc.), high intensity sweeteners, flavors, acids, extracts, fruit concentrates, syrups, minerals, appetite suppressants, honey, lo han guo, thaumatin, neohesperidin, dihydrochalcone, monatin, and the like, may be incorporated into the compositions.

In one embodiment, the disclosure relates to a composition comprising fructose, inulin, water, and a natural high potency sweetener such as stevia. Other ingredients such as fiber, flavors, aromatics, acids, extracts, fruit concentrates, syrups, honey, appetite suppressants, minerals, lo han guo, thaumatin, neohesperidin, dihydrochalcone, monatin, and the like, may be incorporated into the composition.

In another embodiment, the disclosure relates to a composition comprising water, fructose, inulin, and a natural high potency sweetener such as lo han guo. Other ingredients such as fiber, flavors, aromatics, acids, extracts, fruit concentrates, syrups, honey, appetite suppressants, minerals, stevia, thaumatin, neohesperidin, dihydrochalcone, monatin, and the like, may be incorporated into the composition.

In another embodiment, the disclosure relates to a composition comprising fructose, inulin, water and an appetite suppressant such as hoodia, and a natural high potency sweetener such as lo han guo. Other ingredients such as fiber, flavors, aromatics, acids, extracts, fruit concentrates, syrups, honey, appetite suppressants, minerals, stevia, thaumatin, neohesperidin, dihydrochalcone, monatin, and the like, may be incorporated into the composition.

In another embodiment, the disclosure relates to a composition comprising fructose, inulin, a natural flavor such as honey, and a natural high potency sweetener such as lo han guo. Other ingredients such as fiber, flavors, aromatics, acids, extracts, fruit concentrates, syrups, honey, appetite suppressants, minerals, stevia, thaumatin, neohesperidin, dihydrochalcone, monatin, and the like, may be incorporated into the composition.

In another embodiment, the disclosure relates to a composition comprising fructose, inulin, an artificial high potency sweetener such as sucralose, and a natural high potency sweetener such as lo han guo. Other ingredients such as fiber, flavors, aromatics, acids, extracts, fruit concentrates, syrups, honey, appetite suppressants, minerals, stevia, thaumatin, neohesperidin, dihydrochalcone, monatin, and the like, may be incorporated into the composition.

In another embodiment, the disclosure relates to a liquid composition comprising 65% fructose from agave syrup, 30% inulin, and 5% water.

In another embodiment, the disclosure relates to a liquid composition comprising 55% fructose from agave syrup, 40% inulin, and 5% water.

In another embodiment, the disclosure relates to a liquid composition comprising 45% fructose from agave syrup, 50% inulin, and 5% water.

In another embodiment, the disclosure relates to a liquid composition comprising 35% fructose from agave syrup, 60% inulin, and 5% water.

In another embodiment, the disclosure relates to a liquid composition comprising 25% fructose from agave syrup, 70% inulin, and 5% water.

In another embodiment, the disclosure relates to a liquid composition comprising 15% fructose from agave syrup, 80% inulin, and 5% water.

In another embodiment, the disclosure relates to a liquid composition comprising 5% fructose from agave syrup, 90% inulin, and 5% water.

### In the Case of Solid Compositions:

Any of the above liquid compositions when spray dried to remove any excess moisture resulting in a powder inulin. The resulting compositions will controlled levels of sweeteness and inulin depending upon the level of fructose and inulin prior to the spray drying process and the inclusion of any high intensity sweeteners, either natural or artificial.

Additional compositions may be created and spray dried such as those specified below:

In another embodiment, the disclosure relates to a solid composition comprising 1.5% water, 40% natural sweetener such as agave syrup, 59.8% polyol such as maltitol, and 0.20% a high potency natural sweetener such as stevia.

In another embodiment, the disclosure relates to a liquid composition comprising 1.5% water, 40% natural sweetener such as agave nectar, 49.8% polyol such as sorbitol, and 0.25% a high potency natural sweetener such as lo han guo.

In producing the liquid compositions of the present disclosure, there are preferred amounts of agave syrup, natural sweeteners and high potency sweeteners, when used. More particularly, it is preferred to use the following ingredients in the ranges of:

| | | |
|---|---|---|
| Agave Syrup | 26% to | 99.9% (w/w) |
| Water | 0.1% to | 74% (w/w) |
| High potency sweetener, such as lo han | 0.0001% to | 3.5% (w/w) |
| guo | | |

In producing the liquid and solid compositions of the present disclosure, there are still further preferred amounts of agave syrup, natural sweeteners, and high potency sweeteners, when used. More particularly, it is preferred to use the following ingredients in the ranges of:

| | | |
|---|---|---|
| Agave Syrup | 46% to | 99.9% (w/w) |
| Water | 0.1% to | 54% (w/w) |
| High potency sweetener, such as lo han guo | 0.1% to | 1.2% (w/w) |

In the embodiments of the disclosure, the following is applicable.

Any polyol may be utilized in producing the liquid compositions. Examples of suitable polyols include, but are not limited to, maltitol, sorbitol, xylitol, erythritol, lactitol, mannitol, and the like, and mixtures thereof. Specific examples of polyols include, but are not limited to, SORBOGEM™ AND SORBO® by SPI Polyols, NEOSORB™ by Roquette, SORBITOL SOLUTION and CRYSTALLINE SORBITOL by Archer Daniels Midland (ADM), SORBODEX™ by Merck & Co. Inc., MALTISWEET™, STABILITE™ and HYSTAR® by SPI Polyols, MALTISORB® and LYCASIN® by Roquette, MALTIDEX™ and MALBIT™ by Cerestar, Lesys-T® and AMALTY® MR by Towa Chemical Industry Co., Ltd., NUTRIOSE® by Roquette, FIBERSOL® by Matsutani Chemical Industry Co., POLYDEXTROSE® by Danisco.

Crude agave syrup may be extracted from any variety of agave succulents such as Blue Agave Webber or Salmiana.

The Water may be de-ionized water, USP water, de-chlorinated water, mineral water, treated water, or tap water. The preferred water to be used is deionized water.

Stevia rabudiana may be sourced from of one or more, but not limited to, the following companies: AIDP, Inc; Alfa Chem, Amax Nutrasource inc, American Ingredients, AnMar Nutrition, AsiaAmerica Int'l, Inc; Draco Natural Products, Falcon Trading Int'l; GCI Nutrients; Functional Foods Corp; Herb Trade Inc; Motherland Int'l; NuNaturals Inc; Nutriland Group Inc; Nutrichem Resources Co.; NutriScience Innovations LLC; Pharmachem Laboratories Inc; Pharmline Inc; Ria Int'l. LLC; San Francisco Herb & Natural Food Co. Starwest Botanicals; Stauber Performance Ingredients; Strategic Sourcing Inc; Stryka Botanics; P.O. Thomas & Co. Inc; Watson Industries; and the Wright Group,

Lo Han Guo may be consist of, but not limited to, the following ingredients: PureLo by BioVittoria, Mormordica by Draco Natural Products, Lo Han Guo concentrate by AmaxNutrasource, and etc.

Any source of soluble fiber may be utilized in producing the compositions. Conventional sources of fibers are gums, hydrocolloids, mucilages, hemicellulose, pectins, gum Arabic, locust bean gum, polydextrose, inulin, arabinogalactose, hydrolyzed guar gum, xanthan, alginate, carrageenan, beta-glucans, tragacanth, arabinoxylan, and the like, and mixtures thereof.

Any natural sweetener, appetite suppressant, glycemic regulator or high potency sweetener may be used in the present disclosure. Examples of suitable sources include, but are not limited to, gymnema sylvestre, vanadyl sulfate, bitter melon extract, fenugreek extract, bilberry extract, cinnamon extract, jambolan, pterocarpus marsupium, gulvel, d-tagatose, raw organic honey, maple syrup, inulin, barley malt, lactitol, yacon, brown rice syrup, granulated brown rice sweetener, amasake, fruit concentrate, fruit juice sweeteners, organic molasses, sorghum syrup, date sugar, organic dried natural cane juice, trehalose, carralluma fimbriata, nopal cactus (prickly pear) or aloe vera.

Any of the aforementioned ingredients may be used alone or in combination.

### EXAMPLE 1

The compositions of the present disclosure may be prepared by any conventional technique. In the present disclosure, the following is an example in the case of a liquid composition. In this example there is produced a low glycemic, prebiotic liquid sweetener containing high levels of fiber using the following method:
(a) The Agave pulp or root base is cut into smaller pieces that can be milled. The pulp is separated from the syrup.
(b) The syrup is then run through a series of carbon activated filters and mesh screen filters to remove any impurities
(c) Agave Syrup with a fiber content of 25% is metered, or weighed into a mixing vessel;
(d) The syrup is then subjected to hydrolysis and the resulting fructose syrup is collected.
(e) Minerals, color and flavor off-notes are removed via chromatography.
(f) The water is then evaporated off to yield agave derived fructose syrup with natural inulin.
(g) The evaporation process is continued until the desired amount of inulin concentration is attained.
(h) High intensity sweeteners or other additives can be blended in at this point.
   To produce the dry form of the natural inulin the following steps are followed:
(i) The resulting syrup or paste/concentrate is then spray dried using a conventional spray dry equipment and techniques to yield a naturally sweet inulin powder.
(j) After the spray drying step, further additives may be added in an agglomeration method or a simple ad mix ribbon type blender.

### Uses

The low glycemic, prebiotic sweetener by itself or when combined with other specialty ingredients can be used in many industry formulations at varying concentrations to yield a wide array of finished products.

An example of a use in the baked goods industry is in the coating system of a chewing gum. Typical commercial bread formulations have between 2 and 8% high fructose corn syrup in addition to flour, stabilizers, yeast, flavors, colors, etc. A low glycemic, prebiotic agave syrup, can be used instead of the normal high fructose corn syrup solution. Additionally the prebiotic powder composition can be incorporated into the dough to further increase the level of fiber available in the finished application. The resultant loaf of bread will be a lower calorie, higher fiber, lower glycemic value product compared to a normal high fructose corn syrup bread formula.

This disclosure has been described with reference to various specific and illustrative embodiments and techniques.

However, one skilled in the art will recognize that many variations and modifications may be made while retaining within the spirit and scope of the disclosure and the claims.

Having described our invention in such terms as to enable those of skill in the art to understand and use it, and having described the presently preferred embodiments and best mode thereof, We claim:

1. A natural prebiotic syrup concentrate with levels of inulin greater than 5% by weight.

2. A natural prebiotic syrup concentrate of claim 1 with levels of inulin greater than 10% by weight.

3. A natural prebiotic syrup concentrate of claim 1 with levels of inulin in the range of 30% to 99.7% by weight.

4. The composition according to claim 1 further comprising a natural high intensity sweetener such as stevia, thaumatin, lo han guo, or monatin.

5. The composition according to claim 1 further comprising a synthetic high intensity sweetener such as sucralose, neotame, aspartame, or acesulfame potassium.

6. The composition according to claim 1 further comprising an appetite suppressant such as hoodia, Forslean, caralluma fimbriata, nopal (prickly pear cactus) or aloe vera.

7. The composition according to claim 1 further comprising other sources of fiber such as chicory.

8. The composition according to claim 1 further comprising minerals such as chromium, zinc, vanadium, selenium and/or magnesium.

9. The compositions of claim 1 used with or without other ingredients or additives such as binders, active or inactive (inert) ingredients which are homogeneous or non-homogeneous, non-segregating and non-hygroscopic for use in an array of applications such as, but not limited to, dietetic products, pharmaceuticals, food stuffs, and confectionery.

10. The compositions of claim 1 blended with polyols.

11. Prebiotic sweetener compositions, both liquid and solid, comprising water, a natural sweetener, polyols, a high intensity sweetener and other ingredients and/or additives.

12. The compositions of claim 1, spray dried to yield a high fiber prebiotic powder.

13. The composition according to claim 10 further comprising a natural high intensity sweetener such as stevia, thaumatin, lo han guo, or monatin.

14. The composition according to claim 10 further comprising a synthetic high intensity sweetener such as sucralose, neotame, aspartame, or acesulfame potassium.

15. The composition according to claim 10 further comprising an appetite suppressant such as hoodia, Forslean, carraluma fimbriata, nopal (prickly pear cactus) or aloe vera.

16. The composition according to claim 10 further comprising other sources of fiber such as chicory.

17. The composition according to claim 10 further comprising minerals such as chromium, zinc, vanadium, selenium and/or magnesium.

18. The compositions of claim 10 used with or without other ingredients or additives such as binders, active or inactive (inert) ingredients which are homogeneous or non-homogeneous, non-segregating and non-hygroscopic for use in an array of applications such as, but not limited to, dietetic products, pharmaceuticals, food stuffs, and confectionery.

19. The compositions of claim 10 blended with polyols.

20. The process to make compositions of claim 1.
